(19) United States
(12) Patent Application Publication
(10) Pub. No.: US 2019/0256679 A1
(43) Pub. Date: Aug. 22, 2019

(54) NOVEL HYDROCARBON FOAMS WITH Z-1,1,1,4,4,4-HEXAFLUORO-2-BUTENE

(71) Applicant: THE CHEMOURS COMPANY FC, LLC, Wilmington, DE (US)

(72) Inventors: ERNEST BYRON WYSONG, CHADDS FORD, PA (US); BRUCE P. HITCHENS, BEAR, DE (US); JAMES M. TOCYLOSKI, NEWARK, DE (US)

(73) Assignee: THE CHEMOURS COMPANY FC, LLC, Wilmington, DE (US)

(21) Appl. No.: 16/333,785

(22) PCT Filed: Sep. 20, 2017
(86) PCT No.: PCT/US2017/052420

§ 371 Date: Mar. 15, 2019

Related U.S. Application Data
(60) Provisional application No. 62/398,771, filed on Sep. 23, 2016.

(51) Int. Cl. C08J 9/14; C08L 75/04

(52) U.S. Cl. CPC C08J 9/146; C08J 9/149; C08J 9/142; C08L 75/04; C08J 9/145; C08L 2203/14; C08J 2203/164; C08J 2203/182; C08J 2203/202; C08J 2205/052; C08J 2375/04; C08J 2203/12

(57) ABSTRACT

According to one embodiment of the present invention, predominantly closed cell polymer foams are provided which comprise less than 13.5% Z-1336mzz, carbon dioxide and one or more of methyl formate, methylal and trans-dichloroethylene and has a k factor of less than 0.147 BTU-in/hr-ft²-° F. The cellular polymer foam is foamed polyurethane or foamed polyisocyanurate, depending on the identity of the polyisocyanate and active hydrogen-containing compound reactants and their relative amounts. “Active hydrogen” means that the hydrogen is reactive with the isocyanate of the polyisocyanate reactant. The active hydrogen-containing compound contains at least two groups that contain active hydrogen (atoms) that is reactive with isocyanate. The polyurethane and polyisocyanurate reaction products (foamed) resulting from the process of the present invention are polymers. The reaction product can be a mixture of these polymers.

### BACKGROUND INFORMATION

### Field of the Disclosure

This invention relates to the polyurethane foams, methods of making foams and foamable compositions comprising Z-1,1,1,4,4,4-hexafluoro-2-butene with other co-blowing agents and water.

### Description of the Related Art

U.S. 2011/0144216 discloses non-azeotropic compositions containing the Z-HFO-1,1,1,4,4,4-hexafluoro-2-butene mixed with other compounds, that exhibit zero ozone depletion potential (ODP) and ultra-low global warming potential (GWP). Table 1 in '216 discloses more than 100 other compounds and their preferred amounts. '216 also discloses preferred co-blowing agent compositions and amounts of the other compound to be used in conjunction with the Z-isomer. One preferred composition is water in combination with cyclopentane [0035]. Another preferred embodiment comprises 5 to 90 wt % co-blowing agent, preferably 5 to 65 wt %, wherein the co-blowing agent comprises water, HFCs, hydrocarbons, alcohols, CO₂, and combinations thereof [0036]. HFCs are disclosed as being HFC-32, HFC-161, HFC-152, HFC-143, HFC-134, HFC-125, HFC-245, HFC-236, HFC-227ea, HFC-365mfc, HFC-356, and all isomers thereof [0021].

In the preferred composition wherein the co-blowing agent is water, its amount is 5 to 50 wt %, preferably 10 to 40 wt % or 10 to 20 wt % [0037]. In the preferred composition wherein the co-blowing agent is CO₂, its amount is 5 to 60 wt %, preferably 20 to 50 wt % or 40 to 50 wt % [0038]. In the preferred composition when the co-blowing agent is alcohol, its amount is 5 to 40 wt %, preferably 10 to 40 wt % or 15 to 25 wt % [0039]. In the preferred composition when the co-blowing agent is HFC, preferably HFC-152a or HFC-245, wherein HFC-245fa is the preferred C₃ HFC, its amounts are 5 to 80 wt %, 10- to 75 wt % or 25 to 75 wt % [0040]. In the preferred composition wherein the co-blowing agent is hydrocarbon (HC), its amount is 5 to 80 wt %, preferably 20 to 60 wt % [0041].

### SUMMARY

Independent of the voluminous disclosure in US 2010/0144216, it has been discovered that foams blown with mixtures of Z-HFO-1,1,1,4,4,4-hexafluoro-2-butene (Z-1336mzz), carbon dioxide, and one of methyl formate, methylal or trans-dichloroethylene provide improved insulation performance, as evidenced by lower k factors than foams blown with only Z-HFO-1,1,1,4,4,4-hexafluoro-2-butene and carbon dioxide and which comprise 13.5 weight percent or less Z-1336mzz in the polyol composition used to produce such foams. Foams blown with such combinations provide quality foams of low density and low thermal conductivity, especially by spray application.

According to one embodiment of the present invention, predominantly closed cell polymer foams are provided which comprise less than 13.5% Z-1336mzz, carbon dioxide and one or more of methyl formate, methylal and trans-dichloroethylene and has a k factor of less than 0.147 BTU-in/hr-ft²-° F. The cellular polymer foam is foamed polyurethane or foamed polyisocyanurate, depending on the identity of the polyisocyanate and active hydrogen-containing compound reactants and their relative amounts. “Active hydrogen” means that the hydrogen is reactive with the isocyanate of the polyisocyanate reactant. The active hydrogen-containing compound contains at least two groups that contain active hydrogen (atoms) that is reactive with isocyanate. The polyurethane and polyisocyanurate reaction products (foamed) resulting from the process of the present invention are polymers. The reaction product can be a mixture of these polymers.

### DETAILED DESCRIPTION

Described herein are preferred cellular polymer foams which have a k factor less than 0.147 BTU-in/hr-ft²-° F., which comprise a blowing agent composition comprising Z-1336mzz, carbon dioxide and one or more of methyl formate, methylal and trans-dichloroethylene wherein the Z-1336mzz is present at 15.0 weight percent or less in polyol composition used to prepare the foam. In another embodiment, Z-1336mzz is present at 13.5 weight percent. Described also herein are methods of making a foam having a k factor of less than 0.147 BTU-in/hr-ft²-° F. comprising combining and mixing an isocyanate component with an active hydrogen-containing component comprising a blowing agent composition comprising Z-1336mzz in less than 13.5 weight percent of said composition, less than 3.0 weight percent water to generate carbon dioxide and one or more of methyl formate, methylal and trans-dichloroethylene.

In one embodiment, the blowing agent composition comprises Z-1336mzz in an amount up to 15.0 weight percent of the active hydrogen-containing component, less than 3.0 weight percent water, to generate CO₂ upon mixing with isocyanate, and one or more of methyl formate, methylal and trans-dichloroethylene as a co-blowing agent. In another embodiment, the blowing agent composition comprises Z-1336mzz in an amount up to 13.5 weight percent of the active hydrogen-containing component. In one embodiment, water is typically used at levels of from 2% to 3% by weight of the active hydrogen-containing component. In another embodiment, water is used at from 2.4% to 2.7% by weight. In one embodiment, the co-blowing agent is used at from 2% to 6% by weight of the active hydrogen-containing component. In another embodiment the co-blowing agent is used at from 2% to 5% by weight. In yet another embodiment, the co-blowing agent is used at from 2% to 4% by weight. In general as the amount of Z-1336mzz is decreased, the amount of co-blowing agent is increased to provide similar foam density. Methylal is commonly referred to as dimethoxymethane.

The active hydrogen-containing compound reactant in the process of the present invention includes those described in U.S. Pat. No. 4,394,491 and in WO 2014/113379 (isocyanate-reactive groups). Examples of such compounds have at least two hydroxyl groups per molecule, and more specifically comprise polyols, such as polyether or polyester polyols. Some of the hydroxyl groups can be replaced by amine groups, whereby the active hydrogen-containing compound contains both hydroxyl and amine groups. Preferably, the compound contains at least two hydroxyl groups, whereby the compound is a polyol. Examples of such polyols are those which have an equivalent weight of about 50 to about 700, normally of about 70 to about 300, more typically of about 90 to about 270, and carry at least 2 hydroxyl groups, usually 3 to 8 such groups.

Examples of suitable polyols comprise polyester polyols such as aromatic polyester polyols, e.g., those made by transesterifying polyethylene terephthalate (PET) scrap with a glycol such as diethylene glycol, or made by reacting phthalic anhydride with a glycol. The resulting polyester polyols may be reacted further with ethylene and/or propylene oxide to form an extended polyester polyol containing additional internal alkyleneoxy groups.

Additional examples of suitable polyols also comprise polyether polyols such as polyethylene oxides, polypropylene oxides, mixed polyethylene-propylene oxides with terminal hydroxyl groups, among others. Other suitable polyols can be prepared by reacting ethylene and/or propylene oxide with an initiator having 2 to 16, generally 3 to 8 hydroxyl groups as present, for example, in glycerol, pentaerythritol and carbohydrates such as sorbitol, glucose, sucrose and the like polyhydroxy compounds. Suitable polyether polyols can also include aliphatic or aromatic amine-based polyols.

An example of polyol also containing amine is the Mannich polyol. With respect to the polyisocyanate component (reactant), it is normally selected in such proportion relative to that of the active hydrogen-containing compound that the ratio of the equivalents of isocyanate groups to the equivalents of active hydrogen groups, i.e., the foam index, is from about 0.9 to about 10 and in most cases from about 1 to about 4.

While any suitable polyisocyanate can be employed in the instant process, examples of polyisocyanates useful for making polyisocyanate-based foam comprise at least one of aromatic, aliphatic and cycloaliphatic polyisocyanates, among others. Representative members of these compounds comprise diisocyanates such as meta- or paraphenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate (and isomers), napthylene-1,5-diisocyanate, 1-methylphenyl-2,4-phenyldiisocyanate, diphenylmethane-4,4-diisocyanate, diphenylmethane-2,4-diissocyanate, 4,4-biphenylenediisocyanate and 3,3-dimethyoxy-4,4 biphenylenediisocyanate and 3,3-dimethyldiphenylpropane-4,4-diisocyanate; triisocyanates such as toluene-2,4,6-triisocyanate and polyisocyanates such as 4,4-dimethyldiphenylmethane-2,2,5,5-tetraisocyanate and the diverse polymethylenepoly-phenylopolyisocyanates, mixtures thereof, among others.

A crude polyisocyanate may also be used in the practice of this invention, such as the crude toluene diisocyanate obtained by the phosgenating a mixture comprising toluene diamines, or the crude diphenylmethane diisocyanate obtained by the phosgenating crude diphenylmethanediamine. Specific examples of such compounds comprise methylene-bridged polyphenylpolyisocyanates, due to their ability to crosslink the polyurethane.

The polyisocyanate reactant can be a mixture of different polyisocyanates, and the active hydrogen-containing compound can be a mixture of different active-hydrogen-containing compounds.

Typically, before reacting with a suitable polyisocyanate, the active hydrogen-containing compound and optionally other additives are mixed with the blowing agent to form a foam-forming composition. Such foam-forming composition is typically known in the art as an isocyanate-reactive preblend, or B-side composition. The B-side composition contains the active hydrogen-containing compound and preferably also contains the blowing agent composition of the present invention. The A-side composition comprises the polyisocyanate. The foam-forming composition comprising the A-side composition and the B-side composition can be prepared in any manner convenient to one skilled in this art, including simply weighing desired quantities of each component (ingredient) and, thereafter, combining them in an appropriate container at the temperatures and pressures desired.

It is often desirable to employ minor amounts of additives in the B-side composition. Among these additives comprise one or more members from the group consisting of catalysts, surfactants, flame retardants such as TCPP, preservatives, colorants, antioxidants, reinforcing agents, filler, and antistatic agents, among others well known in this art.

Depending upon the composition, a surfactant can be employed to stabilize the foaming reaction mixture while curing. Such surfactants normally comprise a liquid or solid organosilicone compound. The surfactants are employed in amounts sufficient to stabilize the foaming reaction mixture against collapse and to prevent the formation of large, uneven cells. In one embodiment of this invention, about 0.1% to about 5% by weight of surfactant based on the total weight of all foaming ingredients (i.e. blowing agents+active hydrogen-containing compounds+polyisocyanates+additives) are used. In another embodiment of this invention, about 1.5% to about 3% by weight of surfactant based on the total weight of all foaming ingredients are used, i.e. the foamable composition.

One or more catalysts for the reaction of the active hydrogen-containing compounds, e.g. polyols, with the polyisocyanate may be also employed. The selection of catalyst together with the reactants can favor formation of foamed polyisocyanurate instead of or mixed with foamed polyisocyanate in the practice of the process of the present invention. While any suitable urethane catalyst may be employed, specific catalyst comprise tertiary amine compounds and organometallic compounds. Exemplary such catalysts are disclosed, for example, in U.S. Pat. No. 5,164,419, which disclosure is incorporated herein by reference. For example, a catalyst for the trimerization of polyisocyanates, such as an alkali metal alkoxide, alkali metal carboxylate, or quaternary amine compound, may also optionally be employed herein. Such catalysts are used in an amount which measurably increases the rate of reaction of the polyisocyanate. Typical amounts of catalysts are about 0.1% to about 5% by weight based on the total weight of all foaming ingredients.

The process of the present invention is not limited to the specifics disclosed above with respect to the polyisocyanate and active hydrogen-containing compound reactants and the additives present in the A-side or B-side compositions. The relative amounts of polyisocyanate and active-hydrogen-containing compound reactants can be varied to obtain the foam desired, preferably a rigid foam. Excess polyisocyanate reactant can provide a foamed structure of both polyurethane and polyisocyanurate. These are conventional aspects of the present invention, wherein the invention resides in the blowing agent used to produce foaming of the reaction product and in the use of high foaming temperature. Thus, the present invention is applicable to any foamable composition arising from the reaction of polyisocyanate with active hydrogen-containing compound.

In the process of making a polyurethane-based or polyisocyanurate-based foam or polyurethane/polyisocyanurate-based foam, the active hydrogen-containing compound, polyisocyanate and other components are contacted, thoroughly mixed, and permitted to expand and cure into a cellular polymer. The mixing apparatus is not critical, and various conventional types of mixing head and spray apparatus are used. By conventional apparatus is meant apparatus, equipment, and procedures conventionally employed in the preparation of isocyanate-based foams in which conventional isocyanate-based foam blowing agents, such as fluorotrichloromethane (CCl₃F, CFC-11), are employed. Such conventional apparatus are discussed by: H. Boden et al. in chapter 4 of the Polyurethane Handbook, edited by G. Oertel, Hanser Publishers, New York, 1985; a paper by H. Grunbauer et al. titled “Fine Celled CFC-Free Rigid Foam—New Machinery with Low Boiling Blowing Agents” published in Polyurethanes 92 from the Proceedings of the SPI 34th Annual Technical/Marketing Conference, Oct. 21-Oct. 24, 1992, New Orleans, La.; and a paper by M. Taverna et al. titled “Soluble or Insoluble Alternative Blowing Agents? Processing Technologies for Both Alternatives, Presented by the Equipment Manufacturer”, published in Polyurethanes World Congress 1991 from the Proceedings of the SPI/ISOPA Sep. 24-26, 1991, Acropolis, Nice, France.

The temperature of the reaction between polyisocyanate and active hydrogen-containing compound is the temperature of these reactants fed to the mixing apparatus, i.e. the temperature of the reactants at the start of the reaction. The temperature of the reactants is preferably the same, which aids in viscosity matching of the reactants as an aid to complete mixing together of the reactants. The temperature of the reaction is also considered to be the foaming temperature. At the preferred foaming temperature of at least 100° F. (37.7° C.,) it is important that this complete mixing occurs quickly to accommodate the increased reaction rate accompanying this high temperature. If the reactants have a different temperature, it is preferred that the average of their temperatures is at least 100° F. (37.7° C.). Viscosity matching can be accomplished by the reactants being at different temperatures.

The pressure of the apparatus to produce the spray of foaming reaction product can range from low pressure to high pressure. Low pressure is considered to be 100 psi (0.69 MPa) or less, generally at least 50 psi. High pressure is considered to be in the range of 1000 psi (6.9 MPa) to 2000 psi (13.8 MPa). These pressures are gauge pressure.

The invention composition and processes are applicable to the production of all kinds of polyurethane and polyisocyanurate foams, including, for example, integral skin, RIM and flexible foams, and, in particular rigid closed-cell polymer foams useful in spray insulation, as pour-in-place appliance foams, or as rigid insulating board stock and laminates.

This process of the present invention also includes the making of foamed reaction products comprising closed-cell polyurethane or polyisocyanurate polymer. For good thermal performance, preferably, the foam cells within the foamed reaction product are an average of at least 90% closed cells as determined in accordance with ASTM D 6226.

The blowing agent composition of the present invention produces high quality foamed structure, not only characterized by low density and high % closed cells as mentioned above, but also by density uniformity across the thickness of the foamed structure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim, such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole. The transitional phrase “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also include such an invention using the terms “consisting essentially of” or “consisting of.”

### EXAMPLES

A rigorously controlled hand mixed operation was chosen for these examples. The B-side formulation was cooled to 10° C. before premixing with foam expansion agent and A-side (polyisocyanate). The components were mixed at 4000 rpm for 2 seconds before addition to suitable vertical molds. Rise time and tack free time were recorded then the foams were allowed to stand for 24 hours at room temperature (25° C./78° F.) before cutting and characterization via the following methods:

| | |
|---|---|
| Density | ASTM D1622 |
| Thermal conductivity | ASTM C518 |
| Closed cell content | ASTM D6226 |
| Compressive Strength | ASTM D1621 |
| Dimensional Stability | ASTM D2126 |

The B-side composition used in Examples 1-16 is set forth in Table 1.

TABLE 1
Representative B-side composition

| Ingredient | Wt % |
|---|---|
| Polyester polyol | 33.15 |
| Mannich polyol | 25.78 |
| Polyether polyol | 14.73 |
| Tris(chloropropyl)phosphate (TCPP) | 7.37 |
| Silicone surfactant | 1.10 |
| Cyclohexanamine, N,N-dimethyl | 0.81 |
| 1,2-Ethanediamine, N¹-[2-(dimethylamino)ethyl]-N¹,N²,N²- | 0.81 |
| trimethyl- | |
| Dodecanethioic acid, S,S′-(dibutylstannylene) ester | 0.22 |
| Water | 2.55 |
| Methylal | 4.27 |
| Z-1336mzz | 9.21 |
| Total | 100.00 |

The polyester polyol has a hydroxyl number of 300 mg KOH/g, nominal functionality of 2.2, and dynamic viscosity of 5000 cps at 25° C.

The Mannich polyol has a hydroxyl number of 470 mg KOH/g, nominal functionality of 4, and dynamic viscosity of 10000 cps at 25° C.

The polyether polyol has a hydroxyl number of 360 mg KOH/g, nominal functionality of 4.5, and dynamic viscosity of 3000 cps at 25° C.

The results are shown in FIG. 5 in which a constant water level of 2.55% was used for the hydrocarbon blends, while higher water levels were used in the Opteon™ 1100 controls in order to maintain constant density.

TABLE 2
Blowing agent composition and properties

| | | | | | | K factor | % | Den- |
|---|---|---|---|---|---|---|---|---|
| Sam- | | | | | | (BTU-in/ | closed | sity |
| ple | Water | MF | ML | DCE | 1336 | hr-ft²-° F.) | cell | (pcf) |
| 1 | 3.56 | — | — | — | 9.21 | 0.157 | 98.7 | 1.89 |
| 2 | 2.98 | — | — | — | 14.5 | 0.142 | 100 | 1.83 |
| 3 | 2.75 | — | — | — | 16.5 | 0.140 | 100 | 1.84 |
| 4 | 2.55 | 4.27 | — | — | 6.75 | 0.146 | 63.4 | 1.84 |
| 5 | 2.55 | 3.0 | — | — | 10.22 | 0.143 | 72.2 | 1.82 |
| 6 | 2.55 | 2.0 | — | — | 12.96 | 0.142 | 86.7 | 1.81 |
| 7 | 2.55 | — | 4.27 | — | 9.21 | 0.146 | 76.5 | 1.81 |
| 8 | 2.55 | — | 3.00 | — | 11.95 | 0.144 | 83.9 | 1.87 |
| 9 | 2.55 | — | 2.00 | — | 14.11 | 0.141 | 88.8 | 1.86 |
| 10 | 2.55 | — | — | 5.45 | 9.21 | 0.143 | 81.7 | 1.71 |
| 11 | 2.55 | — | — | 3.00 | 13.34 | 0.141 | 87.5 | 1.70 |
| 12 | 2.55 | — | — | 2.00 | 15.03 | 0.140 | 88.6 | 1.75 |
| 13 | 2.75 | | 3.85 | | 8.30 | 0.147 | 69.0 | 1.93 |
| 14 | 3.0 | | 3.32 | | 7.16 | 0.154 | 72.4 | 1.83 |
| 15 | 2.75 | 3.04 | | | 8.30 | 0.150 | 81.6 | 1.92 |
| 16 | 3.0 | 2.62 | | | 7.16 | 0.147 | 83.7 | 1.85 |

Examples 1-3 illustrate foams blown with increasing amounts of CO₂ (generated from water) and corresponding decreasing amounts of Z-1336, and show increasing k factors with decreases in 1336 levels. Examples 4-12 illustrate foams blown with Z-1336, CO₂, and varying amounts of co-blowing agents methyl formate, methyal and trans-dichloroethylene. These foams illustrate significantly lower (better) k factors at the lower levels of 1336.

### COMPARATIVE EXAMPLES

Comparative examples using either HFC-245fa or HFC-365mfc in place of Z-1336mzz with either methyl formate or methylal as co-blowing agent are illustrated in comparative examples 1-12 in table 3 below.

TABLE 3
Comparative Example compositions

| | | | | | | K | |
|---|---|---|---|---|---|---|---|
| | | | | | | factor | |
| | | | | | | (BTU- | |
| | | | | | | in/hr- | Density |
| Sample | Water | MF | ML | 365mfc | 245fa | ft²-° F.) | (pcf) |
| 1 | | — | 4.27 | 9.21 | | 0.158 | 1.67 |
| 2 | 2.55 | — | 3.00 | 1.95 | | 0.151 | 1.59 |
| 3 | 2.55 | — | 2.00- | 14.11 | | 0.150 | 1.69 |
| 4 | 2.55 | 4.27 | — | 6.75 | | 0.156 | 1.71 |
| 5 | 2.55 | 3.0 | — | 10.22 | | 0.150 | 1.64 |
| 6 | 2.55 | 2.0 | — | 12.96 | | 0.153 | 1.62 |
| 7 | 2.55 | 4.27 | | | 5.54 | 0.156 | 1.88 |
| 8 | 2.55 | 3.00 | | | 8.38 | 0.153 | 1.69 |
| 9 | 2.55 | 2.00 | | | 10.63 | 0.151 | 1.84 |
| 10 | 2.55 | — | 4.27 | | 7.55 | 0.155 | 1.75 |
| 11 | 2.55 | — | 3.00 | | 9.8 | 0.152 | 1.79 |
| 12 | 2.55 | — | 2.00 | | 11.58 | 0.152 | 1.62 |

Foams blown with hydrofluorocarbon blowing agents HFC-245fa and HFC-365mfc do not show the same lower k factors when used with methyl formate and methylal as was observed in examples 4-9 with HFO-1336mzz.

What is claimed is:

1. A predominantly closed cell polymer foam obtained from a foam forming composition comprising less than 14.0 weight percent Z-1,1,1,4,4,4-hexafluoro-2-butene, less than 3.0 weight percent water, and at least one of methyl formate, methylal or trans-dichloroethylene, said foam having a k factor of less than 0.147 BTU-in/hr-ft²-° F.

2. The composition of claim 1, wherein the polymer of said foam is a polyurethane or polyisocyanurate.

3. The composition of claim 1, wherein the polymer foam has a density of less than 2.0 pounds per cubic foot.

4. The composition of claim 1, wherein methyl formate and methylal are present in from 2% to 4.5% weight percent and trans-dichloroethylene is present in from 2% to 5.5% by weight.

5. The composition of claim 1, wherein said water is present in from 2% to 4% by weight.

6. The composition of claim 1, wherein the k factor is less than 0.145 BTU-in/hr-ft²-° F.
